(19) United States
(12) Patent Application Publication
(10) Pub. No.: US 2017/0214300 A1
(43) Pub. Date: Jul. 27, 2017

(54) BONDED TYPE LAMINATED-CORE MEMBER MANUFACTURING APPARATUS AND ADHESIVE APPLYING UNIT FOR THE SAME

(71) Applicant: POSCO TMC CO., LTD., Cheonan-si, Chungcheongnam-do (KR)

(72) Inventors: Il Gwen CHUNG, Seoul (KR); Jae Young LEE, Suwon-si, Gyeonggi-do (KR); Jae Sang KWON, Pyeongtaek-si, Gyeonggi-do (KR); Jae Chun YOU, Cheonan-si, Chungcheongnam-do (KR)

(73) Assignee: POSCO TMC CO., LTD., Cheonan-si, Chungcheongnam-do (KR)

(21) Appl. No.: 15/314,096

(22) PCT Filed: Mar. 31, 2015
(86) PCT No.: PCT/KR2015/003210

§ 371 Date: Nov. 28, 2016

(30) Foreign Application Priority Data
May 28, 2014 (KR) 10-2014-0064541

(51) Int. Cl. H02K 15/02; B32B 37/12

(52) U.S. Cl. CPC H02K 15/02; B32B 37/12; B32B 2605/00

(57) ABSTRACT

Disclosed herein is a bonded type laminated-core member manufacturing apparatus comprising an adhesive applying unit which is selectively open for applying an adhesive to a material being continuously transferred, and a blanking unit sequentially forming laminar members having a predetermined shape by blanking the material, wherein the adhesive applying unit includes an adhesive applicator having an outlet channel for discharging the adhesive, and a valve closing the outlet channel and opening the outlet channel for discharging the adhesive when the material and the outlet channel come close to each other. since an outlet of a nozzle is opened only when a material approaches an adhesive applying unit and close when the material separates from the adhesive applying unit, leakage of the adhesive prevent can be prevented and the discharge time and the application amount of the adhesive may be regularly controlled.

### TECHNICAL FIELD

The present invention relates to a core member manufacturing apparatus used to manufacture a core of a motor, a generator, etc. and, more particularly, to a bonded type laminated-core member manufacturing apparatus to manufacture a laminated-core member for a motor by interlayer adhesion between laminar members, and an adhesive applying unit for manufacturing the bonded type laminated-core member.

### BACKGROUND ART

In general, a laminated core manufactured by laminating and integrating laminar members is used as a rotor or a stator of a generator or a motor and, as methods of manufacturing laminated cores, i.e., by laminating the laminar members and then integrally fixing the laminar members, a tap fixing method using interlock taps, a fixing method using welding, for example, laser welding, a rivet fixing method, etc. have been known.

The tap fixing method is disclosed as manufacturing technology of a laminated-core member in Patent Documents, i.e., Korean Patent Laid-open Publication Nos. 10-2008-0067426 and 10-2008-0067428. In manufacture of the laminated-core member using such a method, iron loss occurs, particularly, it is difficult to execute embossing due to thickness reduction in a material, i.e., a steel sheet, and thus it is limited as technology for manufacturing laminated cores. The above-described Patent Documents and Patent Documents which will be described later disclose various kinds and shapes of laminated-core members.

Recently, an adhesion fixing method, in which laminar members forming a laminated-core member are adhered to each other by an adhesive so as to be integrated, has been proposed. Such an adhesion fixing method is disclosed in Korean Patent Laid-open Publication No. 10-1996-0003021 and Japanese Patent Laid-open Publication No. H5-304037.

With reference to the Japanese Patent Laid-open Publication No. H5-304037 among the above-described Patent Documents, a material for manufacturing a motor core, i.e., a steel sheet, is fed to a first press die and a second press die by a feed roller and, before the steel sheet is supplied to the first press die, an adhesive is applied to the surface of the steel sheet by an application roller and a nozzle.

Further, blanked members sequentially accumulated in the first press die and the second press die due to blanking of the material are integrated by the adhesive, thereby manufacturing an adhesive laminated core.

The above-described adhesion fixing methods, i.e., the bonded type laminated core manufacturing method, may reduce manufacturing costs, as compared to the laser welding method, and correspond to thickness reduction in the steel sheet, but precise control in application of the adhesive and blanking of the material is required, since elements, such as the press dies, the nozzles, the application roller, etc., are separately provided and independently operated.

Further, in a conventional laminated core manufacturing apparatus using an adhesive, an outlet of a nozzle to apply the adhesive may cause leakage of the adhesive or pollution around the outlet, the adhesive leaked from the nozzle may be adhered to the surface of the nozzle and thus cause clogging of the outlet of the nozzle and pollution. These problems may disturb precise application of a fixed quantity of the adhesive and reduction in the hardening time.

Moreover, the conventional laminated core manufacturing apparatus has a difficulty in applying a regular amount of the adhesive to the surface of a steel sheet each designated cycle, and requires precise management of the adhesive supply pressure, i.e., the pressure of the adhesive within the nozzle, so as to accurately control the discharge quantity of the adhesive and the operation time of the nozzle (application timing of the adhesive), and, if an adhesive application process is not effectively executed, delamination of the laminated core occurs and causes a defective product and, thus, productivity may be lowered due to increase in a defect rate and management costs may be increased.

### DISCLOSURE

### Technical Problem

Therefore, the present invention has been made in view of the above problems, and it is an object of the present invention to provide a bonded type laminated-core member manufacturing apparatus and an adhesive applying unit which may apply the adhesive precisely for interlayer adhesion between laminar members and prevent leakage of the adhesive, pollution around an outlet of a nozzle and clogging of the outlet.

### Technical Solution

In accordance with an aspect of the present invention, the above object can be accomplished by the provision of a bonded type laminated-core member manufacturing apparatus comprising an adhesive applying unit which is selectively open for applying an adhesive to a material being continuously transferred, and a blanking unit sequentially forming laminar members having a predetermined shape by blanking the material, wherein the adhesive applying unit includes an adhesive applicator having an outlet channel for discharging the adhesive, and a valve closing the outlet channel and opening the outlet channel for discharging the adhesive when the material and the outlet channel come close to each other.

The valve may include a valve plug which is movably inserted into the outlet channel for opening and closing the outlet channel.

The valve plug opens the outlet channel when pressed by the material, and a front end of the valve plug protrudes outward from the outlet channel for moving to a blocking position of the outlet channel and closing the outlet channel when external force applied to the valve plug by the material is removed.

And the valve plug may block the outlet channel by the pressure of the inside of the adhesive applicator.

The valve may further include a valve supporter supporting the valve plug for returning the valve plug to a blocking position of the outlet channel.

The valve supporter may include a coil spring elastically supporting the valve plug.

The outlet channel includes an outlet for discharging the adhesive and a passage reduction part gradually narrowed in the direction of the outlet, and the valve plug has a shape, the width of which is gradually decreased in the front direction, so as to correspond to the shape of the outlet channel.

The blanking unit includes, a blank punch provided on an upper frame upper of the bonded type laminated-core member manufacturing apparatus, and a blank die provided on a lower frame of the bonded type laminated-core member manufacturing apparatus, the adhesive applicator is provided on the lower frame, together with the blank die, a pressure member to pressurize the material toward the adhesive applicator is provided on the upper frame, and the adhesive applicator is provided at an upstream region in the transfer direction of the material, as compared to the blank die.

The adhesive applicator may receive the adhesive from an adhesive supplier, and the adhesive supplier may include an adhesive tank receiving the adhesive and an adhesive pressurizer including a pneumatic device, a hydraulic device, a pump or piston for supplying the adhesive from the adhesive tank to the adhesive applicator. The piston is movably provided in the adhesive tank, pressed by a weight and pushes the adhesive.

In accordance with another aspect of the present invention, there is provided an adhesive applying unit applying an adhesive to a material for a laminated-core member manufactured by interlayer adhesion between laminar members laminated in the vertical direction, the adhesive applying unit comprising an adhesive applicator including an adhesive reception room receiving the adhesive and an outlet channel being the outlet of adhesive reception room and facing the material for discharging the adhesive, and a valve closing the outlet channel and opening the outlet channel for discharging the adhesive when the material and the outlet channel come close to each other.

### Advantageous Effects

A bonded type laminated-core member manufacturing apparatus and an adhesive applying unit in accordance with the present invention have effects, as below.

First, in accordance with the embodiment of the present invention, since an outlet of a nozzle is opened only when a material approaches an adhesive applying unit and close when the material separates from the adhesive applying unit, leakage of the adhesive prevent can be prevented and the discharge time and the application amount of the adhesive may be regularly controlled.

Second, in accordance with the embodiment of the present invention, since the outlet is opened only when the adhesive applying unit discharge the adhesive, leakage of the adhesive prevent can be prevented. And, since elements such as a valve and nozzle is made of Teflon having anti-adhesion, clogging of the outlet and a passage (channel) by hardening and adhesion of the adhesive may be prevented, spreading of a hardened clot of the adhesive spread to surface of the material may be prevented, and an error in interlayer adhesion of the laminated-core member may be prevented.

Third, in accordance with the embodiment of the present invention, since a blanking punch to blank a metal strip and a pressure member to press the metal strip toward the adhesive applicator are mounted on an upper press die and thus simultaneously elevated, a blanking process and an adhesive application process corresponding to pre-process of the blanking process may be simultaneously executed by synchronization of the blanking punch and the pressure member, and adhesive application timing may be stably and accurately maintained.

### DESCRIPTION OF DRAWINGS

The above and other objects, features and other advantages of the present invention will be more clearly understood from the following detailed description taken in conjunction with the accompanying drawings, in which:

FIG. 1 is a longitudinal-sectional view schematically illustrating a bonded type laminated-core member manufacturing apparatus in accordance with one embodiment of the present invention, taken in the transfer direction of a material;

FIG. 2 is a longitudinal-sectional view illustrating an adhesive applying unit in accordance with one embodiment of the present invention, taken along line A-A of FIG. 1;

FIG. 3 is an exploded sectional view illustrating an adhesive applicator and a valve of the adhesive applying unit shown in FIG. 2;

FIG. 4 is longitudinal-sectional views illustrating operation of the adhesive applying unit shown in FIG. 2;

FIG. 5 is a view illustrating another embodiment of an adhesive applying unit of a bonded type laminated-core member manufacturing apparatus in accordance with another embodiment of the present invention;

FIG. 6 is a longitudinal-sectional view taken along line B-B of FIG. 1;

FIG. 7 is a cross-sectional view illustrating one embodiment of a laminating barrel integrating laminar members;

FIG. 8 is a plan view exemplarily illustrating an adhesive application process and a blanking process by the bonded type laminated-core member manufacturing apparatus shown in FIG. 1; and

FIGS. 9 are plan views illustrating various examples of core members.

### BEST MODE

Hereinafter, embodiments of the present invention will be described in detail with reference to the accompanying drawings. In description of the embodiments of the invention, the same or similar elements are denoted by the same reference numerals even though they are depicted in different drawings.

The present invention relates to a bonded type laminated-core member manufacturing apparatus which manufactures a laminated-core member for motor cores by forming laminar members having a designated shape by blanking a strip-type material, which is continuously transferred, and executing interlayer adhesion between the laminar members, and a adhesive applying unit which applies an adhesive to the strip-type material for the interlayer adhesion between the laminar members.

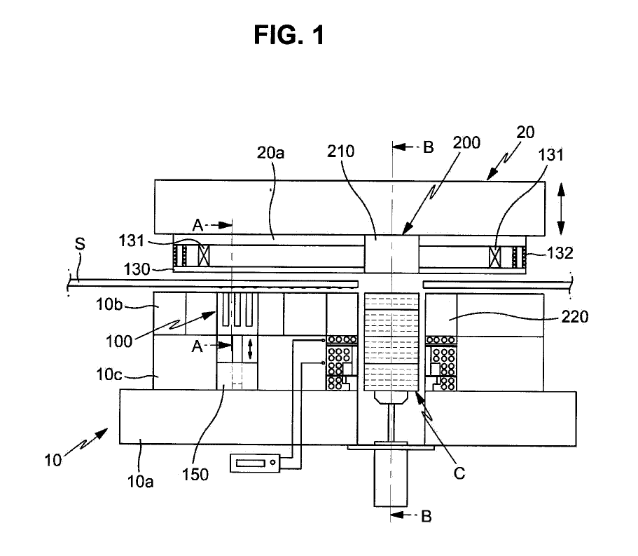

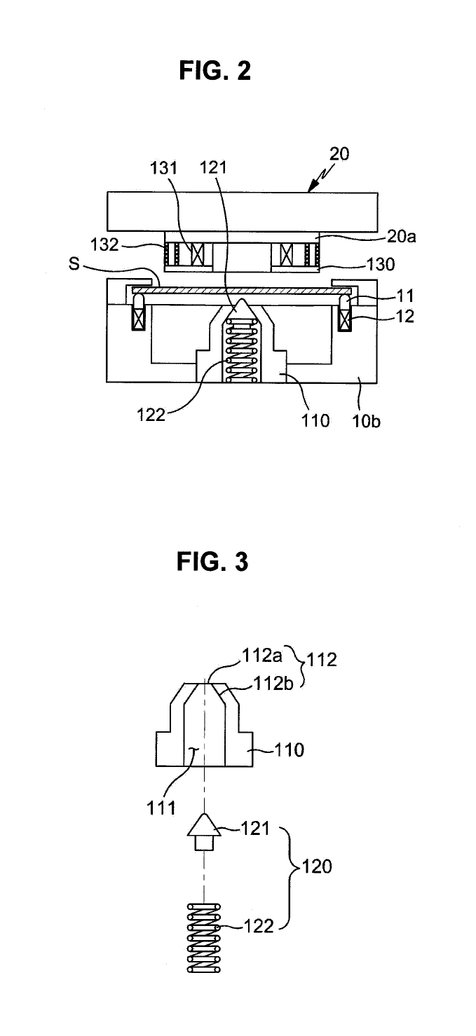

With reference to FIGS. 1 to 9, an adhesive applying unit and a bonded type laminated-core member manufacturing apparatus having the same in accordance with one embodiment of the present invention will be described. FIG. 1 is a longitudinal-sectional view schematically illustrating a bonded type laminated-core member manufacturing apparatus in accordance with one embodiment of the present invention, taken in the transfer direction of a material, FIG. 2 is a longitudinal-sectional view illustrating an adhesive applying unit in accordance with one embodiment of the present invention, taken along line A-A of FIG. 1, and FIG. 3 is an exploded sectional view illustrating an adhesive applicator and a valve of the adhesive applying unit shown in FIG. 2.

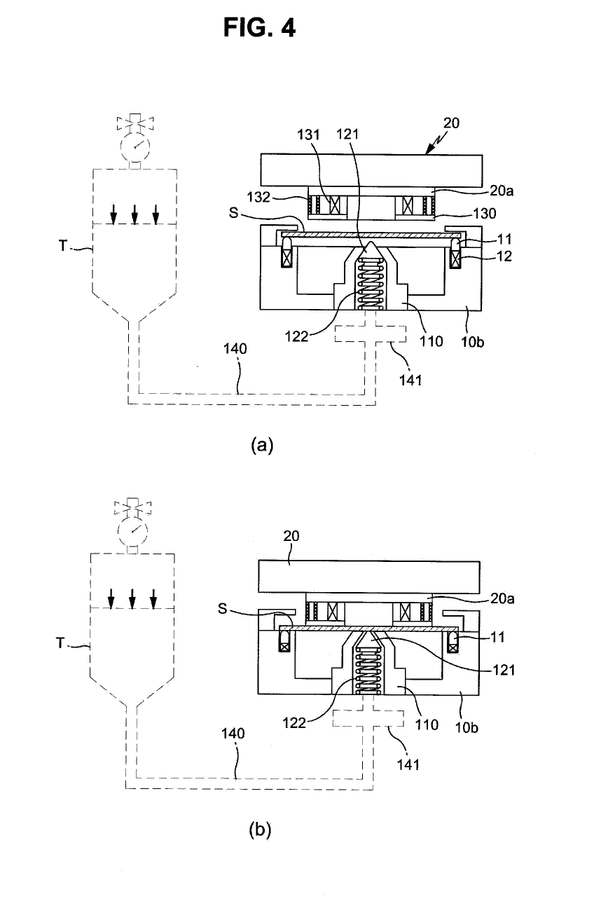

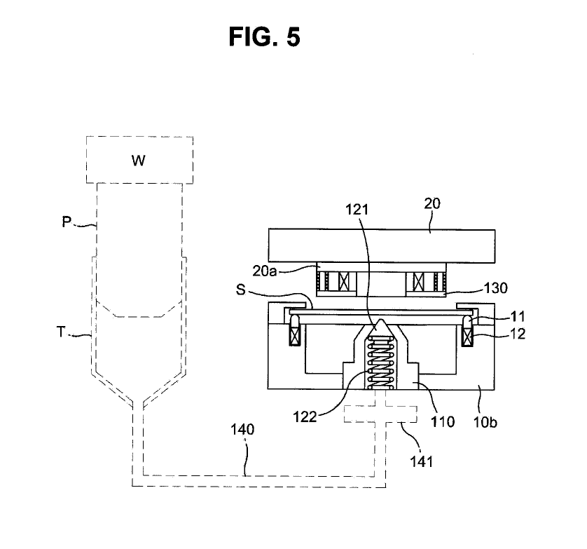

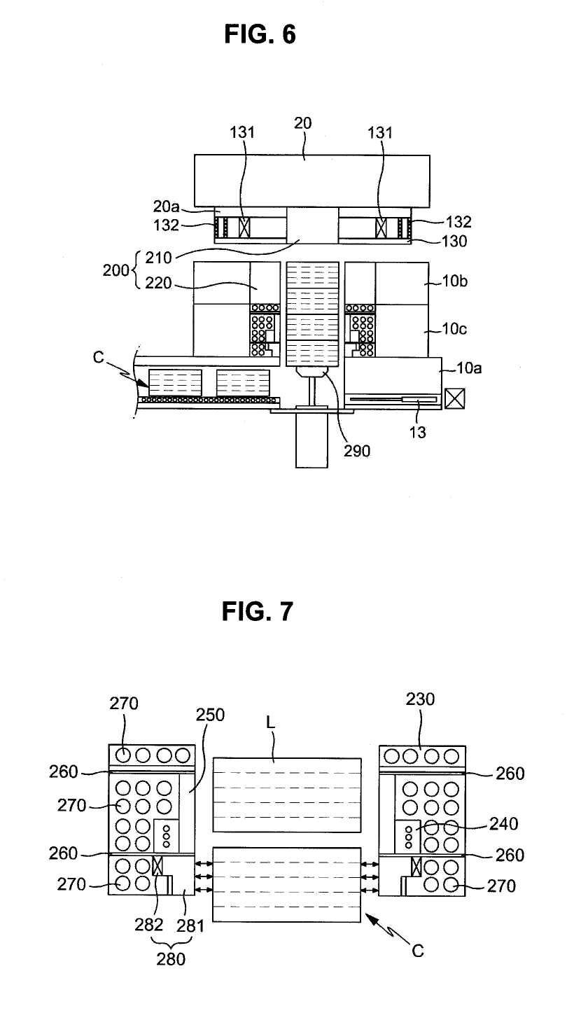

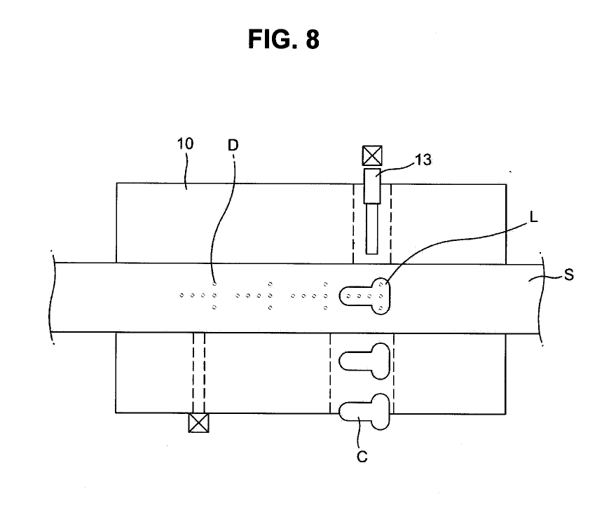

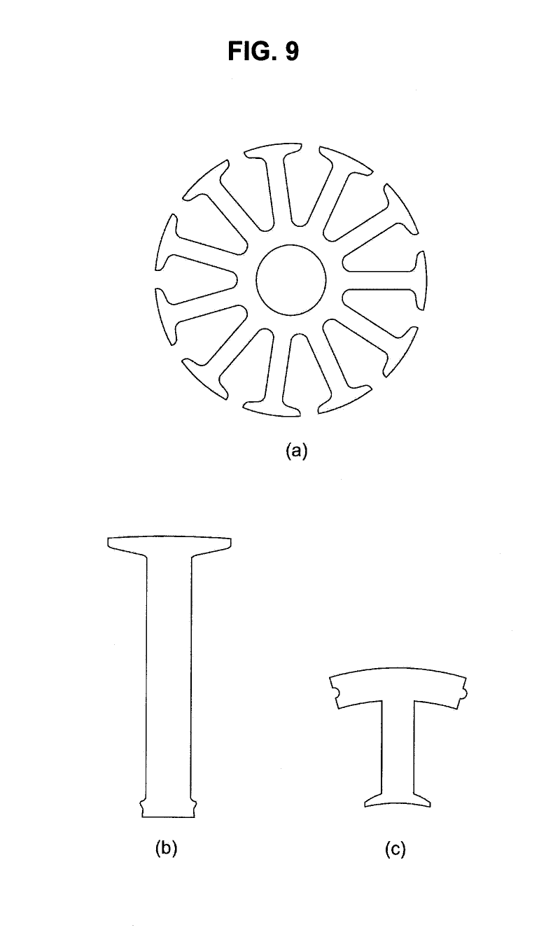

FIG. 4 is longitudinal-sectional views illustrating operation of the adhesive applying unit shown in FIG. 2, FIG. 5 is a view illustrating another embodiment of an adhesive applying unit of a bonded type laminated-core member manufacturing apparatus in accordance with another embodiment of the present invention, FIG. 6 is a longitudinal-sectional view taken along line B-B of FIG. 1, FIG. 7 is a cross-sectional view illustrating one embodiment of a laminating barrel integrating laminar members, FIG. 8 is a plan view exemplarily illustrating an adhesive application process and a blanking process by the bonded type laminated-core member manufacturing apparatus shown in FIG. 1, and FIGS. 9 are plan views illustrating various examples of core members.

First, with reference to FIGS. 1 to 3, the bonded type laminated-core member manufacturing apparatus in accordance with this embodiment includes an adhesive applying unit 100 and blanking unit 200. The adhesive applying unit 100 is selectively opened at a designated position per designated timing so as to apply an adhesive to the continuously transferred material S, for example, a steel sheet for manufacturing a motor core (hereinafter, referred to as a “metal strip”). And the blanking unit 200 blanking unit 300 sequentially forms the laminar members having a designated shape by blanking the metal strip S, for example, electrical steel. In this embodiment, the blanking unit 200 is provided downstream in the transfer direction of the metal strip S, as compared to the adhesive applying unit 100, and executes the blanking process after the adhesive application process.

The adhesive applying unit 100 includes an adhesive applicator 110 which is selectively opened to apply the adhesive at a designated position per designated timing, i.e., each designated cycle, to apply the adhesive to the surface of the metal strip S, for example, the lower surface of the metal strip S, and a valve 120 to open and close an outlet of the adhesive applicator 110 to apply the adhesive.

In this embodiment, the adhesive applying unit 100 is a nozzle type which is pressed by the metal strip S and is thus opened to transfer (discharge) the adhesive to the surface of the metal strip S in a dot pattern. In more detail, the adhesive applicator 110 corresponding to a nozzle body includes a nozzle path 111 filled with the adhesive and an outlet channel 112 forming the outlet of the adhesive applicator 110.

Here, the adhesive applicator 110 corresponds to a nozzle body (hereinafter, denoted by the same reference numeral as “the adhesive applicator”), and the outlet channel 112 corresponds to a nozzle outlet formed to face the metal strip S so as to form the outlet of the nozzle path 211. When the valve 120 is opened, the adhesive of a designated pressure received in an adhesive reception room 141 (with reference to FIG. 4) is applied to the surface of the metal strip S through the outlet channel 112.

Further, the valve 120 closes the outlet channel 112 and then opens the outlet channel 112, i.e., the nozzle outlet, when the metal strip S and the outlet channel 112 come close to each other. That is, the valve 110 opens the nozzle outlet (hereinafter, denoted by the same reference numeral as “the outlet channel”) only at the adhesive application timing.

The valve 120 includes a valve plug 121 which is movably inserted into the outlet channel 112 so as to open and close the outlet channel 112. In this embodiment, the valve plug 121 is pressed by the metal strip S and thus opens the outlet channel 112. Then, when external force applied to the valve plug 121 by the metal strip S is removed, the valve plug 121 moves to a blocking position of the outlet channel 112, the front end of the valve plug 121 protrudes outward from the outlet channel 112, i.e., the nozzle outlet, and, consequently, the outlet channel 112 is closed.

In this embodiment, the metal strip S is pressed by a pressure member 130 and thus descends and, when the metal strip S comes close to the nozzle body 110 and the front end of the valve plug 121 is pressed by the metal strip S, the valve plug 121 moves backward (descends) to the inside of the nozzle body 110 and thus opens the nozzle outlet 112.

And, when the metal strip S ascends and becomes distant from the nozzle body 110, the valve plug 121 returns to an original position thereof, i.e., moves forward (ascends) and closes again the nozzle outlet 112. The valve plug 121 closes the nozzle outlet 112 by the pressure of a fluid within the nozzle body 110 and/or a valve supporter 122 which returns the valve plug 121 to the nozzle blocking position.

The valve supporter 122 may include a spring which elastically supports the valve plug 121, for example, a coil spring. One end (the lower end) of the coil spring is installed on the bottom of the nozzle body 110 and the other end (the upper end) of the coil spring is connected to the valve plug 121 so as to provide elastic force in the direction of the nozzle outlet to the valve plug 121.

With reference to FIGS. 2 and 3, the outlet channel 112 includes an outlet 112a to discharge the adhesive and a passage reduction part 112b gradually narrowed in the direction of the outlet 112a. Further, the valve plug 121 may have a shape, the width of which is gradually decreased in the forward direction (upward direction), so as to correspond to (match) the shape of the outlet channel 112. For example, the upper structure of the valve plug 121 may have a conical shape or a polygonal pyramid shape.

In this embodiment, the nozzle body 110 is provided in the lower frame (lower press die) 10, particularly, the die frame 10b. Lifters 11 and lift springs 12 supporting the lifters 11 in the upward direction are provided on the die frame 10b. The lifters 11 elastically support the metal strip S in the upward direction and thus space the metal strip S apart from the adhesive applicator 110.

Therefore, when the pressure member 130 ascends, the metal strip S becomes distant from the nozzle body 110 and, when force pressing the valve plug 121 in the downward direction is removed, the valve plug 121 returns to the nozzle blocking position thereof by the pressure of the inside of the nozzle (the pressure of the inside of the adhesive reception room) and/or the valve supporter 122.

With reference to FIGS. 2 and 4, the nozzle body, i.e., the adhesive applicator, 110 receives the adhesive through an adhesive supply pipe 140 of an adhesive supplier. In more detail, the adhesive received in an adhesive tank T is supplied at a designated pressure to the nozzle body 110 through the adhesive supply pipe 140 by a pneumatic device applying air pressure or other pumps.

That is, the adhesive supplier includes the adhesive tank T and an adhesive pressurizer to apply pressure to the adhesive received in the adhesive tank T, such as a pneumatic device, a hydraulic device or other pumps, and the adhesive is supplied to the nozzle body 110 via the adhesive supply pipe 140 and the adhesive reception room 141.

The adhesive applying unit 100 may include a plurality of nozzle bodies 110 installed in parallel, and the nozzle bodies 110 are respectively disposed at adhesive application positions D (with reference to FIG. 8, the adhesive being applied in a dot pattern to a plurality of points of a T-shaped laminar member L). In this embodiment, the adhesive in the adhesive tank T is distributed at a designated pressure through the adhesive reception room 141 and is simultaneously supplied to the nozzle bodies 110. That is, the adhesive of a designated pressure is uniformly supplied to the nozzle bodies 110 connected to the adhesive reception room 141 in parallel, thus being simultaneously applied to a plurality of points, i.e., a plurality of positions. Further, the adhesive reception rooms 141, more particularly, the inside of the nozzle bodies 110, are filled with the adhesive at a designated pressure and, when the valve plug 121 is opened by the pressure member 130, the adhesive within the nozzle body 110 is pushed to the outside by the pressure applied by the pneumatic device and is applied to the surface of the metal strip S.

The height of the upper end of the nozzle body 110 may coincide with the height of the upper surface of the die frame 10b, and the upper surface of the die frame 10b may become a bottom dead center (lower limit) of the metal strip S. Further, a structure, in which, when the metal strip S descends to the bottom dead center, the metal strip S and the upper end of the nozzle body 110 are spaced apart from each other by a designated interval, facilitates discharge and application of the adhesive.

The pressure member 130 is provided on the upper press die 20 and is configured so as to ascend together with the upper press die 20. In more detail, the pressure member 130 is provided on the upper frame 20a installed above the die frame 10b so as to be spaced apart from the die frame 10b by a designated interval and, in this embodiment, the pressure member 130 ascends integrally with the upper press die 20. Therefore, the upper press die 20 becomes an upper holder to support the pressure member 130, and the die frame 10b of the lower press die 10 becomes a lower holder to support the nozzle body 110. A plurality of nozzle bodies 110 may be disposed in parallel on the die frame 10b so as to coincide with the shape of the core member C.

The adhesive applicator, i.e., the nozzle body 110 is descended each designated cycle by a nozzle elevating device 150 provided on the lower press die 10, particularly the lower holder 10c, for example, an elevating device, such as a cam mechanism or a hydraulic/pneumatic cylinder, thus preventing application of the adhesive to the metal strip S. In more detail, if the laminated-core member has a 10-layer structure including 10 laminar members L, the adhesive application process is omitted whenever the metal strip S moves up to 10 pitches and, thereby, adhesion between the laminated-core members C can be prevented.

For this purpose, the nozzle elevating device 150 descends the nozzle body 110 once whenever the metal strip S moves by predetermined pitches, thus preventing the valve plug 121 from being pressurized by the metal strip S. In the laminated-core members C shown in FIG. 1, a dotted line represents a portion in which interlayer adhesion is executed, and a solid line represents a boundary between the laminated-core members C without interlayer adhesion.

In this embodiment, the lower press die 10 includes a base frame 10a forming the base part of the lower press die 10 and a die 10b and 10c provided on the base frame 10a, and the nozzle body 110 is installed in the die. The die 10b and 10c is divided into the die frame 10b in which the nozzle body 110 is installed, and the die holder 10c provided under the die frame 10b, the nozzle elevating device 150 being installed in the die holder 10c. Nozzle installation holes are formed at the die frame 10b but the structure of the lower press die 10, particularly the die frame 10b, is not limited thereto.

Therefore, the adhesive applying unit 100 in accordance with this embodiment includes the lower press die 10, the adhesive applicator 110 provided in the lower press die 10, more particularly the die frame 10b, the valve 120 provided in the adhesive applicator 110 to open and close the adhesive applicator 110, the upper press die 20 provided above the lower press die 10, and the pressure member 130 provided on the upper press die 20, more particularly the upper frame 20a.

The adhesive applicator 110, i.e., the nozzle body, the valve plug 121 and the valve supporter 122 may be manufactured of a material which prevents or minimizes adhesion of the adhesive thereto, that is, a plastic having no polarity or low surface tension, in detail, Teflon, or a material to which the adhesive is scarcely adhered, such as polypropylene (PP) or polyethylene (PE).

Hereinafter, operation of the adhesive applying unit 100 in accordance with this embodiment will be described with reference to FIG. 4.

The metal strip S moves to a predetermined distance each predetermined cycle, i.e., per press stroke, and passes through a space between the pressure member 130 and the die frame 10b, and, when the metal strip S reaches the adhesive application position, as exemplarily shown in (a) of FIG. 4, the upper press die 20 pressurizes the metal strip S, as exemplarily shown in (b) of FIG. 4. Thereby, the metal strip S pressurizes the valve plugs 121 and thus opens the nozzle outlet 112, and the adhesive in the nozzle body 110 is pushed to the outside by internal pressure and is applied to the surface of the metal strip S.

Then, when the upper press die 20 ascends, the metal strip S becomes distant from the nozzle outlet 112 by the lifter 11 and lifter spring 12, and the valve plug 121 is raised and again closes the nozzle outlet 112, as exemplarily shown in (a) of FIG. 4.

However, a syringe-type adhesive supplier may be used, as exemplarily shown in FIG. 5, so that the adhesive fills the nozzle body 110 by gravity rather than pneumatic pressure or hydraulic pressure. That is, the adhesive supplier may include an adhesive tank T, a piston P, and a weight W. In more detail, the piston P, which is provided in the adhesive tank T, is lowered by the weight W and thus supplies the adhesive within the adhesive tank T to the nozzle body 110. That is, the weight W is lowered due to gravity and causes the piston P to enter the adhesive tank T.

With reference to FIG. 1 and FIG. 6 to FIG. 8, the blanking unit 200 includes a blank punch 210 and a blank die 220, and sequentially forms laminar members L having a designated shape by blanking the metal strip S continuously passing through a space between the blank punch 210 and the blank die 220. The blank die 220 has a blanking hole having a designated shape opposite the blank punch 210, and the laminar members L are input to the blanking hole of the blank die 220, simultaneously with blanking. Although FIGS. 1, 6, and 7 illustrate that a blanking region of the metal strip S has a greater area than that of the laminar member L, it is apparent to those skilled in the art that the blanking region and the laminar members L have the substantially same size and shape, and the laminar members L having the same size and shape as the blank die 220, i.e., the blanking hole, are formed.

In this embodiment, the blank punch 210 is provided on an upper frame 20a, and the blank die 220 is provided on a die frame 10b. In more detail, in order to execute a blanking process subsequent to an adhesive application process, the blanking die 220 is located downstream in the transfer direction of the metal strip S, as compared to the nozzle body 110. And the nozzle body 110 and the blanking die 220 are provided on a die frame 10b.

Further, the blank punch 210 opposite to blank die 220 and a pressure member 130 are provided on the upper frame 20a and elevated and lowered integrally with the upper press die 20. Therefore, when the blanking process by the blanking unit 200 is executed on the metal strip S, the adhesive application process by the adhesive application unit 100 is executed at an upstream portion of the metal strip S, spaced apart from the blanking unit 200 by a designated pitch, simultaneously with the blanking process.

In this embodiment, the pressure member 130 is a compressed plate or a pressure plate which functions as a stripper in the blanking process and simultaneously pressurizes the metal strip S toward the nozzle bodies 110 in the adhesive application process, and elastic members (for example, coil springs 131) and guides 132 to guide elevation of the pressure member 130 are provided between the pressure member 130 and the upper frame 20a. The blanking unit 200 blanks the metal strip S and integrates the laminar members L sequentially manufactured by blanking, and a laminating barrel to pass the sequentially stacked laminar members L so as to integrate the laminar members L is provided under the blank die 220.

In more detail, a squeezer 230, which is provided under the blank die 220, squeezes the sequentially stacked laminar members L to align the laminar members passing through the squeezer 230 in the downward direction toward an adhesive hardener 240, and the adhesive hardener 240, which is provided under the squeezer 230, integrates the laminar members L by hardening the adhesive interposed between the laminar members L.

The squeezer 230 supports the laminar members L so as to prevent falling of the laminar members and a laminating error, i.e., an alignment error when the laminar members are sequentially stacked by blanking the metal strip, and may include a squeezer ring which has the same shape of the inside of the blanking hole. Therefore, if the laminar members L have a circular outer surface, the squeezer ring has a circular shaped ring and, if the laminar members L have a T shape, the squeezer ring has a T shaped hole. The laminar members L in the shrink-fit state into the squeezer 230 are pushed by the blank punch 210 and thus pass through the squeezer 230.

In this embodiment, a guide 250 is provided within the adhesive hardener 240. The guide 250 guides line alignment of objects to be heated, located within the adhesive hardener 240, and straight penetration of the objects to be heated (straight extraction of a product) and the guide 250 may employ a guide formed of a nonconductive material, for example, engineering ceramics.

The adhesive hardener 240 is a high-frequency induction heater which hardens the adhesive using high-frequency induction heating so as to increase the hardening speed of the adhesive, and includes a heating coil. However, the adhesive hardener is not limited to the high-frequency induction heating type.

A blocking member 260 for thermal insulation between the squeezer 230 and the adhesive hardener 240 may be provided on upper side of the adhesive hardener 240. The blocking member 260 thermally insulate the squeezer 230 and the adhesive hardener 240 from each other and thus minimizes or prevents heating of other peripheral parts by high-frequency induction heating except for the inner region of the adhesive hardener 240 through which the laminar members L pass. For example, as the blocking member, a shielding material formed of beryllium copper may be used.

Further, cooling paths 270, for example, cooling water paths, to cool the lower press die 10, particularly a die holder 10c, may be provided around the adhesive hardener 240, and cooling paths 270 may be provided in the squeezer 230.

And, this embodiment may further include pincher 280 provided under the adhesive hardener 240. The pincher 280 applies lateral pressure to a product (a laminated and hardened core member) C passing through a space between the pinchers 120 and thus assists alignment of the product C moving downward from the adhesive hardener 240 and prevents the product C, i.e., the core member, from rapidly falling. The pincher 280 includes a pincher block 281 and a pincher spring 282 which is an elastic member to elastically support the pincher block 281, and the pincher 280 pinches the side surface of a product discharged from the adhesive hardener 240, i.e., the core member C, and prevent rapidly falling of the core member C after passing through the adhesive hardener 240 and eccentricity of the core member C from the center of the laminating barrel. A plurality of pincher blocks 281 is spaced apart from each other along the circumference of the laminated core member C within the laminating barrel, for example, is installed at designated angles within the laminating barrel. Although the pinchers 280 may be formed as a moving type or a fixed type, moving type pincher 280 may be preferable in consideration of thermal expansion. The moving type pinchers 280 elastically support the side surface of the core member C.

Further, the above blocking member 260 may be provided between the adhesive hardener 240 and the pinchers 280, and the cooling paths 270 may be provided around pinchers 280, i.e., at the circumference of the pinchers 280.

The blank die 220, the squeezer 230, the guide 250 and the pinchers 280 are disposed coaxially on the lower press die 10, and an extraction support 290 to support the lower surface of a product (the laminated core member C) extracted through the lamination and hardening processes is provided on the bottom of the laminating barrel and elevates for extraction of the laminated core member C.

The extraction support 290, in a state in which the core members C are seated on the extraction support 290, is lowered and, when the extraction support 290 reaches the bottom of the laminating barrel, an extraction cylinder 13 pushes the core member C to an extraction passage and thus assists extraction of the product.

Although FIG. 7 illustrates an interval between the lower core member C and another core member C provided thereon, the core members C are actually directly stacked so as to contact each other and thus continuously pass through the laminating barrel. Further, the side surfaces of the laminar members L and the side surfaces of the laminated core members C closely contact the inner surface of the laminating barrel, more particularly, the inner surfaces of the squeezer 230, the guide 250 and the pinchers 280.

Hereinafter, a process of manufacturing an adhesive laminated core member by the above-described laminated-core member manufacturing apparatus will be described.

When the metal strip S is supplied by a material transfer device (not shown), such as a transfer roller, so that the metal strip S passes through a space between the pressure member 130, i.e., a stripper, and the die frame 10b while moving by 1 pitch, the pressure member 130 and the blank punch 210 mounted on the upper press die 20 are lowered integrally with the upper press die 20 and thus pressurize the upper surface of the metal strip S.

Here, the metal strip S is pressurized by the pressure member 130 and is thus lowered towards the nozzle body 110. And the valve plug 121 is pressurized by the metal strip S and thus opens the outlet of the nozzle body 110. Thereby, the adhesive is applied to portions of the surface of the metal strip S, which is located just above the adhesive applicators, i.e., the nozzle body 110.

Simultaneously with the above-described adhesive application process, blanking of the metal strip S by the blank punch 210 descended simultaneously with the pressure member 130 is carried out at a downstream region, as compared to the adhesive applied region, and integration of laminar members L sequentially laminated by blanking is carried out within the laminating barrel.

The laminating barrel is a hollow passage formed by the above-described squeezer 230, adhesive hardener 240, pinchers 280, and blank die 220, and lamination of the laminar members L and hardening of the adhesive are carried out in the laminating barrel.

The squeezer 230 and the pinchers 280 align products passing through the laminating barrel, i.e., the laminar members and laminated core members, and the adhesive hardener 240 hardens the adhesive interposed between the laminar members L using heat generated by high-frequency induction.

When application of the adhesive and blanking of the metal strip S are completed, the upper press die 20 is elevated, the metal strip S is separated from the valve plugs 121 by the lifter 11 and the lifter spring 12, and the nozzle outlet 112 are closed again. Thereafter, when the metal strip S moves again by 1 pitch, the above-described process is repeated and thus manufacture of an adhesive laminated core member C is carried out.

In this embodiment, the laminar member L refers to a thin monolayer sheet manufactured by blanking the material. Further, the laminated-core member C forms a stator or a rotor of a motor and may form at least one part of a core, for example, a core wing on which a coil is wound. FIG. 9 shows various examples of laminated-core members.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Although some embodiments have been described herein, it should be understood by those skilled in the art that these embodiments are given by way of illustration only and the present invention is not limited thereto, and that various modifications, variations, and alterations can be made by those skilled in the art without departing from the spirit and scope of the present invention. Therefore, the scope of the invention should be limited only by the accompanying claims and equivalents thereof.

### INDUSTRIAL APPLICABILITY

As apparent from the above description, the present invention relates to a core manufacturing apparatus, which manufactures a core used as a rotor or stator of a motor or a generator, and a process of manufacturing a core using the same, and may facilitate alignment and lamination of thin plates forming the core and rapidly and easily integrate the thin plates.

1. A bonded type laminated-core member manufacturing apparatus comprising:
an adhesive applying unit which is selectively open for applying an adhesive to a material being continuously transferred; and
a blanking unit sequentially forming laminar members having a predetermined shape by blanking the material,
wherein the adhesive applying unit includes:
an adhesive applicator having an outlet channel for discharging the adhesive; and
a valve closing the outlet channel and opening the outlet channel for discharging the adhesive when the material and the outlet channel come close to each other.

2. The bonded type laminated-core member manufacturing apparatus according to claim 1, wherein the valve includes a valve plug which is movably inserted into the outlet channel for opening and closing the outlet channel.

3. The bonded type laminated-core member manufacturing apparatus according to claim 2, wherein the valve plug opens the outlet channel when pressed by the material, and a front end of the valve plug protrudes outward from the outlet channel for moving to a blocking position of the outlet channel and closing the outlet channel when external force applied to the valve plug by the material is removed.

4. The bonded type laminated-core member manufacturing apparatus according to claim 3, wherein the valve plug blocks the outlet channel by the pressure of the inside of the adhesive applicator.

5. The bonded type laminated-core member manufacturing apparatus according to claim 3, wherein the valve further includes a valve supporter supporting the valve plug for returning the valve plug to a blocking position of the outlet channel.

6. The bonded type laminated-core member manufacturing apparatus according to claim 5, wherein the valve supporter includes a coil spring elastically supporting the valve plug.

7. The bonded type laminated-core member manufacturing apparatus according to claim 3, wherein the outlet channel includes an outlet for discharging the adhesive and a passage reduction part gradually narrowed in the direction of the outlet, and the valve plug has a shape, the width of which is gradually decreased in the front direction, so as to correspond to the shape of the outlet channel.

8. The bonded type laminated-core member manufacturing apparatus according to claim 1, wherein the blanking unit includes, a blank punch provided on an upper frame upper of the bonded type laminated-core member manufacturing apparatus, and a blank die provided on a lower frame of the bonded type laminated-core member manufacturing apparatus;
wherein the adhesive applicator is provided on the lower frame, together with the blank die;
wherein a pressure member to pressurize the material toward the adhesive applicator is provided on the upper frame; and
wherein the adhesive applicator is provided at an upstream region in the transfer direction of the material, as compared to the blank die.

9. The bonded type laminated-core member manufacturing apparatus according to claim 1, wherein the adhesive applicator receives the adhesive from an adhesive supplier, and wherein the adhesive supplier includes an adhesive tank receiving the adhesive and an adhesive pressurizer including a pneumatic device, a hydraulic device, a pump or piston for supplying the adhesive from the adhesive tank to the adhesive applicator; the piston being movably provided in the adhesive tank, pressed by a weight and pushing the adhesive.

10. An adhesive applying unit applying an adhesive to a material for a laminated-core member manufactured by interlayer adhesion between laminar members laminated in the vertical direction, the adhesive applying unit comprising:
an adhesive applicator including an adhesive reception room receiving the adhesive and an outlet channel being the outlet of adhesive reception room and facing the material for discharging the adhesive; and
a valve closing the outlet channel and opening the outlet channel for discharging the adhesive when the material and the outlet channel come close to each other.

11. The bonded type laminated-core member manufacturing apparatus according to claim 4, wherein the valve further includes a valve supporter supporting the valve plug for returning the valve plug to a blocking position of the outlet channel.

12. The bonded type laminated-core member manufacturing apparatus according to claim 11, wherein the valve supporter includes a coil spring elastically supporting the valve plug.

13. The bonded type laminated-core member manufacturing apparatus according to claim 4, wherein the outlet channel includes an outlet for discharging the adhesive and a passage reduction part gradually narrowed in the direction of the outlet, and the valve plug has a shape, the width of which is gradually decreased in the front direction, so as to correspond to the shape of the outlet channel.
